(19) United States
(12) Patent Application Publication
(10) Pub. No.: US 2014/0213723 A1
(43) Pub. Date: Jul. 31, 2014

(54) POLYIMIDE PRECURSOR COMPOSITION AND METHOD FOR PREPARING POLYIMIDE PRECURSOR COMPOSITION

(71) Applicant: FUJI XEROX CO., LTD., Tokyo (JP)

(72) Inventors: Tsuyoshi MIYAMOTO, Kanagawa (JP); Katsumi NUKADA, Kanagawa (JP)

(73) Assignee: FUJI XEROX CO., LTD., Tokyo (JP)

(21) Appl. No.: 14/038,162

(22) Filed: Sep. 26, 2013

(30) Foreign Application Priority Data
Jan. 31, 2013 (JP) 2013-017930

(51) Int. Cl. C08K 5/1575; C08K 5/05; C08K 5/07; C08K 5/1535

(52) U.S. Cl. CPC C08K 5/1575; C08K 5/1535; C08K 5/05; C08K 5/07
USPC 524/754; 524/751; 524/767; 524/770

(57) ABSTRACT

A polyimide precursor composition includes an organic amine compound and a resin which contains a repeating unit represented by the following Formula (I) and has an imidization rate of 0.2 or less dissolved in a solvent containing water and one or more kinds of organic solvents selected from a water-soluble ether solvent, a water-soluble ketone solvent, and a water-soluble alcohol solvent:

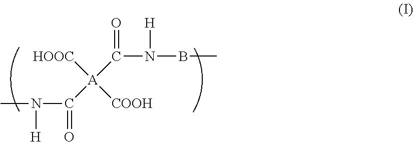

wherein A represents a tetravalent organic group, and B represents a divalent organic group.

### CROSS-REFERENCE TO RELATED APPLICATIONS

This application is based on and claims priority under 35 USC 119 from Japanese Patent Application No. 2013-017930 filed Jan. 31, 2013.

### BACKGROUND

1. Technical Field

The present invention relates to a polyimide precursor composition and a method for preparing a polyimide precursor composition.

2. Related Art

A polyimide resin is a material having characteristics of being excellent in high durability and thermal resistance, and is widely used for electronic materials.

### SUMMARY

According to an aspect of the invention, there is provided a polyimide precursor composition, including an organic amine compound and a resin which contains a repeating unit represented by the following Formula (I) and has an imidization rate of 0.2 or less dissolved in a solvent containing water and one or more kinds of organic solvents selected from a water-soluble ether solvent, a water-soluble ketone solvent, and a water-soluble alcohol solvent:

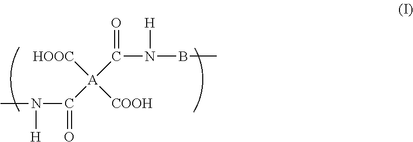

wherein A represents a tetravalent organic group, and B represents a divalent organic group.

### DETAILED DESCRIPTION

Hereinafter, exemplary embodiments of the present invention will be described in detail.

Polyimide Precursor Composition

The polyimide precursor composition according to the present exemplary embodiment is a composition in which an organic amine compound and a resin (hereinafter, called a “specific polyimide precursor”) which contains a repeating unit represented by Formula (I) and has an imidization rate of 0.2 or less have dissolved in a solvent. That is, the specific polyimide precursor and the organic amine compound are contained in the composition, in a state of being dissolved in a solvent. Moreover, the term “dissolved” means a state where a residue of the dissolved substance is not visually confirmed.

As the solvent, a solvent which contains water and one or more kinds of organic solvents (hereinafter, called “specific organic solvents”) selected from a water-soluble ether solvent, water-soluble ketone solvent, and a water-soluble alcohol solvent is used.

The polyimide precursor composition according to the present exemplary embodiment is a composition not containing a non-protonic polar solvent.

The non-protonic polar solvent refers to a solvent having a boiling point of 150° C. to 300° C. and a dipole moment of 3.0 D to 5.0 D. Specific examples of the non-protonic polar solvent include N-methyl-2-pyrrolidone (NMP), N,N-dimethylacetamide (DMF), N,N-dimethylformamide (DMAc), dimethylsulfoxide (DMSO), hexamethylenephosphoramide (HMPA), N-methylcaprolactam, N-acetyl-2-pyrrolidone, and the like.

The non-protonic polar solvent represented by N-methyl-2-pyrrolidone (NMP) has a high boiling point which is 150° C. or higher, and this solvent in the composition remains in a molded article in many cases even after a drying process in the preparation of a polyimide-molded article. If the non-protonic polar solvent remains in the polyimide-molded article, reorientation of a polymer chain of the polyimide precursor occurs, and packing properties of the polymer chain deteriorate. Accordingly, mechanical strength of the obtained polyimide-molded article decreases in some cases.

On the other hand, the polyimide precursor composition according to the present exemplary embodiment uses, as a solvent, not a non-protonic polar solvent but a solvent containing specific organic solvents and water. Accordingly, the obtained polyimide-molded article does not contain the non-protonic polar solvent.

The specific polyimide precursor as a polyimide precursor is not a low-molecular weight compound and does not have a structure that has increased the solubility thereof in a solvent by introducing a flexural chain, a aliphatic cyclic structure, or the like into the primary structure to reduce the force of interaction between polymer chains. The specific polyimide precursor uses, as the solvent, a solvent containing the specific organic solvents and water, and in this solvent, the specific polyimide precursor (a carboxyl group thereof) has dissolved in a state of being made into an amine salt by an organic amine compound. Therefore, decrease in the mechanical strength of the polyimide-molded article that is caused when the molecular weight of the polyimide precursor is reduced or the structure is changed is suppressed.

Accordingly, it is considered that from the polyimide precursor composition according to the present exemplary embodiment, a polyimide resin-molded article having a high mechanical strength is obtained due to the above composition.

In addition, from the polyimide precursor composition according to the present exemplary embodiment, a polyimide resin-molded article excellent in various properties such as thermal resistance, electrical characteristics, and solvent resistance in addition to the mechanical strength is easily obtained.

Moreover, the polyimide precursor composition according to the present exemplary embodiment uses, as a solvent, a mixed solvent containing the specific organic solvents and water, and in this solvent, the specific polyimide precursor (a carboxyl group thereof) has dissolved in a state of being made into an amine salt by an organic amine compound. Accordingly, the polyimide precursor composition has a high degree of film formability and excellent in environmental suitability.

If the mixed solvent containing the specific organic solvents and water is used as a solvent, when a polyimide-molded article is formed of the polyimide precursor composition, the heating temperature for distilling away the solvent is reduced, and the heating time is shortened.

In addition, the organic amine compound has dissolved in the solvent in a state of being made into an amine salt of the specific polyimide precursor (a carboxyl group thereof). Therefore, the odor unique to the amine compound is suppressed.

Particularly, when the specific polyimide precursor (that is, an aromatic polyimide precursor) represented by Formula (I) in which A represents a tetravalent aromatic organic group and B represents a divalent aromatic organic group is used, the precursor tends not to easily dissolve in the solvent in general. However, if a solvent containing the specific organic solvents and water is used as the solvent, the specific polyimide precursor dissolves in this solvent in a state of being made into an amine salt by an organic amine compound. Accordingly, even when the aromatic polyimide precursor is used as the specific polyimide precursor, the film formability is high, and the environmental suitability is excellent.

Hereinafter, the respective components of the polyimide precursor composition according to the present exemplary embodiment will be described.

Specific Polyimide Precursor

The specific polyimide precursor is a resin (a polyamic acid) which contains a repeating unit represented by Formula (I) and has an imidization rate of 0.2 or less.

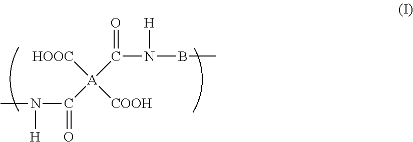

In Formula (I), A represents a tetravalent organic group, and B represents a divalent organic group.

In Formula (I), the tetravalent organic group represented by A is a residue remaining after four carboxyl groups are removed from a tetracarboxylic dianhydride as a raw material.

Meanwhile, the divalent organic group represented by B is a residue remaining after two amino groups are removed from a diamine compound as a raw material.

That is, the specific polyimide precursor containing the repeating unit represented by Formula (I) is a polymer of a tetracarboxylic dianhydride and a diamine compound.

Examples of the tetracarboxylic dianhydride include all of the aromatic and aliphatic compounds, and among these, aromatic compounds are preferable. That is, in Formula (I), the tetravalent organic group represented by A is preferably an aromatic organic group.

Examples of the aromatic tetracarboxylic acid include pyromellitic dianhydride, 3,3′,4,4′-benzophenone tetracarboxylic dianhydride, 3,3′,4,4′-biphenylsulfone tetracarboxylic dianhydride, 1,4,5,8-naphthalene tetracarboxylic dianhydride, 2,3,6,7-naphthalene tetracarboxylic dianhydride, 3,3′,4,4′-biphenylether tetracarboxylic dianhydride, 3,3′,4,4′-dimethyldiphenylsilane tetracarboxylic dianhydride, 3,3′,4,4′-tetraphenylsilane tetracarboxylic dianhydride, 1,2,3,4-furantetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4″-bis(3,4-dicarboxyphenoxy)diphenylpropane dianhydride, 3,3′,4,4′-perfluoroisopropylidene diphthalic dianhydride, 3,3′,4,4′-biphenyltetracarboxylic dianhydride, 2,3,3′,4-biphenyltetracarboxylic dianhydride, bis(phthalic acid) phenylphosphine oxide dianhydride, p-phenylene-bis(triphenylphthalic acid)dianhydride, m-phenylene-bis(triphenylphthalic acid)dianhydride, bis(triphenylphthalic acid)-4,4′-diphenylether dianhydride, bis(triphenylphthalic acid)-4,4′-diphenylmethane dianhydride, and the like.

Examples of the aliphatic tetracarboxylic dianhydride include aliphatic or alicyclic tetracarboxylic dianhydrides such as butane tetracarboxylic dianhydride, 1,2,3,4-cyclobutane tetracarboxylic dianhydride, 1,3-dimethyl-1,2,3,4-cyclobutane tetracarboxylic dianhydride, 1,2,3,4-cyclopentane tetracarboxylic dianhydride, 2,3,5-tricarboxycyclopentyl acetic dianhydride, 3,5,6-tricarboxynorbornane-2-acetic dianhydride, 2,3,4,5-tetrahydrofuran tetracarboxylic dianhydride, 5-(2,5-dioxotetrahydrofuryl)-3-methyl-3-cyclohexene-1,2-dicarboxylic dianhydride, and bicyclo[2,2,2]-oct-7-ene-2,3,5,6-tetracarboxylic dianhydride; aliphatic tetracarboxylic dianhydrides having an aromatic ring, such as 1,3,3a,4,5,9b-(hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione; and the like.

Among these, aromatic tetracarboxylic dianhydrides are preferable as the tetracarboxylic dianhydride. Specifically, for example, pyromellitic dianhydride, 3,3′,4,4′-biphenyltetracarboxylic dianhydride, 2,3,3′,4′-biphenyltetracarboxylic dianhydride, 3,3′,4,4′-diphenylether tetracarboxylic dianhydride, and 3,3′,4,4′-benzophenone tetracarboxylic dianhydride are preferable, pyromellitic dianhydride, 3,3′,4,4′-biphenyltetracarboxylic dianhydride, and 3,3′,4,4′-benzophenone tetracarboxylic dianhydride are more preferable, and 3,3′,4,4′-biphenyltetracarboxylic dianhydride is particularly preferable.

One kind of the tetracarboxylic dianhydride may be used alone, or two or more kinds thereof may be concurrently used in combination. Moreover, when two or more kinds thereof are concurrently used in combination, the aromatic tetracarboxylic acids or the aliphatic tetracarboxylic acids may be concurrently used respectively, or the aromatic tetracarboxylic acid may be combined with the aliphatic tetracarboxylic acid.

Meanwhile, the diamine compound is a diamine compound having two amino groups in the molecular structure. Examples of the diamine compound include all of the aromatic and aliphatic compounds, and among these, aromatic compounds are preferable. That is, in Formula (I), the divalent organic group represented by B is preferably an aromatic organic group.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenylether, 4,4′-diaminodiphenylsulfide, 4,4′-diaminodiphenylsulfone, 1,5-diaminonaphthalene, 3,3-dimethyl-4,4′-diaminobiphenyl, 5-amino-1-(4′-aminophenyl)-1,3,3-trimethylindane, 6-amino-1-(4′-aminophenyl)-1,3,3-trimethylindane, 4,4′-diaminobenzanilide, 3,5-diamino-3′-trifluoromethylbenzanilide, 3,5-diamino-4′-trifluoromethylbenzanilide, 3,4′-diaminodiphenylether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; aromatic diamines having two amino groups bonded to an aromatic ring such as diaminotetraphenyl thiophene and hetero atoms other than nitrogen atoms of the amino groups; aliphatic and alicyclic diamines such as 1,1-metaxylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoindanylene dimethylenediamine, tricyclo[6,2,1,0^{2,7}]-undecylene dimethyldiamine, and 4,4′-methylenebis(cyclohexylamine); and the like.

Among these, aromatic diamine compounds are preferable as the diamine compound. Specifically, for example, p-phenylenediamine, 4,4′-diaminodiphenylmethane, 4,4′-diaminodiphenylether, 3,4′-diaminodiphenylether, 4,4′-diaminodiphenylsulfide, and 4,4′-diaminodiphenylsulfone are preferable, and 4,4′-diaminodiphenylether and p-phenylenediamine are particularly preferable.

One kind of the diamine compound may be used alone, or two or more kinds thereof may be concurrently used in combination. Moreover, when two or more kinds thereof are concurrently used in combination, the aromatic diamine compounds or the aliphatic diamine compounds may be concurrently used respectively, or the aromatic diamine compound may be combined with the aliphatic diamine compound.

The specific polyimide precursor is a resin having an imidization rate of 0.2 or less. That is, the specific polyimide precursor may be a partially imidized resin.

Specific examples of the specific polyimide precursor include resins containing the repeating units represented by Formulae (I-1), (I-2), and (I-3).

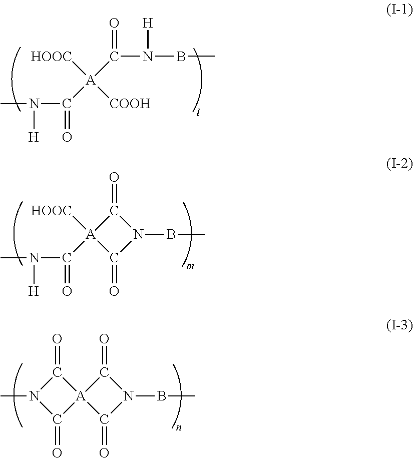

In Formulae (I-1), (I-2), and (I-3), A represents a tetravalent organic group, and B represents a divalent organic group. Moreover, A and B have the same definition as that of A and B in Formula (I).

1 represents an integer of 1 or greater, and each of m and n independently represents 0 or an integer of 1 or greater and satisfies the relationship of (2n+m)/(2l+2m+2n)≦0.2.

In Formulae (I-1) to (I-3), 1 preferably represents an integer of 1 or greater, more preferably represents an integer of 1 to 200, and still more preferably represents an integer of 1 to 100. Each of m and n independently represents 0 or an integer of 1 or greater, more preferably represents 0 or an integer of 1 to 200, and still more preferably represents 0 or an integer of 1 to 100.

In addition, l, m, and n satisfy the relationship of (2n+m)/(2l+2m+2n)≦0.2, preferably satisfy the relationship of (2n+m)/(2l+2m+2n)≦0.15, and more preferably satisfy the relationship of (2n+m)/(2l+2m+2n)≦0.10.

In Formulae (I-1), (I-2), and (I-3), A represents a tetravalent organic group, and B represents a divalent organic group. Moreover, A and B have the same definition as that of A and B in Formula (I).

Each of l, m, and n independently represents 0 or an integer of 1 or greater and satisfies the relationship of (2n+m)/(2l+2m+2n)≦0.2. Here, at least one of 1 and m represents an integer of 1 or greater.

In Formulae (I-1) to (I-3), each of l, m, and n independently represents 0 or an integer of 1 or greater, preferably represents 0 or an integer of 1 to 200, and more preferably represents 0 or an integer of 1 to 100.

In addition, l, m, and n satisfy the relationship of (2n+m)/(2l+2m+2n)≦0.2, preferably satisfy the relationship of (2n+m)/(2l+2m+2n)≦0.15, and more preferably satisfy the relationship of (2n+m)/(2l+2m+2n)≦0.10.

Here, at least one of 1 and m represents an integer of 1 or greater.

Herein, “(2n+m)/(2l+2m+2n)” indicates a ratio of the number of binding portion (2n+m) showing imide ring closure to the total number of binding portion (2l+2m+2n) in binding portions (portions where the tetracarboxylic dianhydride reacts with the diamine compound) of the specific polyimide precursor. That is, “(2n+m)/(2l+2m+2n)” indicates an imidization rate of the specific polyimide precursor.

If the imidization rate (value of “(2n+m)/(2l+2m+2n)”) of the specific polyimide precursor is controlled to be 0.2 or less (preferably 0.15 or less and more preferably 0.10), the specific polyimide precursor is suppressed from being gelated or separated by precipitation.

The imidization rate (value of “(2n+m)/(2l+2m+2n)”) of the specific polyimide precursor is measured by the following method.

Measurement of Imidization Rate of Polyimide Precursor

Preparation of Polyimide Precursor Sample

(i) The polyimide precursor composition to be measured is coated onto a silicone wafer in a film thickness ranging from 1 μm to 10 μm to prepare a coating film sample.

(ii) The coating film sample is dipped in tetrahydrofuran (hereinafter, described as THF) for 20 minutes to replace the solvent in the coating film sample with THF. The solvent for dipping is not limited to THF and may be selected from solvents that do not dissolve the polyimide precursor and may be mixed with a solvent component not contained in the polyimide precursor composition. Specifically, alcohol solvents such as methanol and ethanol and ether compounds such as dioxane (hereinafter, described as DOX) are usable.

(iii) The coating film sample is taken out of THF, and N₂ gas is blown to THF on the surface of the coating film sample to remove THF. The coating film sample is dried by being treated for 12 hours or longer within a range of 5° C. to 25° C. under a pressure reduced to 10 mmHg or less, thereby preparing a polyimide precursor sample.

Preparation of 100% Imidized Standard Sample

(iv) the polyimide precursor composition to be measured is coated onto a silicone wafer in the same manner as in the section (i) to prepare a coating film sample.

(v) The coating film sample is subjected to a imidization reaction by being heated for 60 minutes at 380° C., thereby preparing a 100% imidized standard sample.

Measurement and Analysis

(vi) By using a Fourier transform infrared spectrophotometer (FT-730 manufactured by HORIBA, Ltd.), the infrared absorption spectrum of the 100% imidized standard sample and the polyimide precursor sample is measured. The 100% imidized standard sample is measured to determine a ratio I′(100) of an absorption peak (Ab′(1780 cm⁻¹)) derived from an imide bond around 1780 cm⁻¹ to an absorption peak (Ab′(1500 cm⁻¹)) derived from an aromatic ring around 1500 cm⁻¹.

(vii) Likewise, the polyimide precursor sample is measured to determine a ratio I(x) of an absorption peak (Ab(1780 cm⁻¹)) derived from an imide bond around 1780 cm⁻¹ to an absorption peak (Ab(1500 cm⁻¹)) derived from an aromatic ring around 1500 cm⁻¹.

In addition, by using the measured absorption peaks I′ (100) and I(x) respectively, an imidization rate of the polyimide precursor is calculated based on the following formula.

Formula: imidization rate of polyimide precursor=I(x)/I′(100)

Formula: (100)=(Ab′(1780 cm⁻¹))/(Ab′(1500 cm⁻¹))

Formula: I(x)=(Ab(1780 cm⁻¹))/(Ab(1500 cm⁻¹))

This measurement of an imidization rate of the polyimide precursor is applied to the measurement of an imidization rate of an aromatic polyimide precursor. For measuring the imidization rate of an aliphatic polyimide precursor, instead of the absorption peak of an aromatic ring, a peak derived from a structure that does not change before and after the imidization reaction is used as an internal standard peak.

Terminal Amino Group of Polyimide Precursor

The specific polyimide precursor preferably includes a polyimide precursor (resin) having an amino group on the terminal thereof, and preferably is an polyimide precursor having amino groups on all terminals thereof.

For example, if the diamine compound used for the polymerization reaction is added in a molar equivalent that is higher than a molar equivalent of the tetracarboxylic dianhydride during the polymerization reaction, amino groups are provided to both molecular terminals of the polyimide precursor. The molar equivalent ratio between the diamine compound and the tetracarboxylic dianhydride preferably within a range of 1.0001 to 1.2 and more preferably within a range of 1.001 to 1.2, based on the 1 molar equivalent of the tetracarboxylic acid.

If the molar equivalent ratio between a diamine compound and the tetracarboxylic dianhydride is 1.0001 or higher, amino groups on the molecular terminal exert a great effect, and excellent dispersibility is obtained. If the molar equivalent ratio is 1.2 or less, the molecular weight of the obtained polyimide precursor becomes high, and for example, a sufficient film strength (tear strength and tensile strength) is easily obtained when a film-shaped polyimide-molded article is formed.

The terminal amino groups of the specific polyimide precursor are detected by causing a trifluoroacetic anhydride (quantitatively reacting with the amino group) to act on the polyimide precursor. That is, the terminal amino groups of the specific polyimide precursor are amidated by the trifluoroacetic acid. After being treated, the specific polyimide precursor is purified by reprecipitation or the like to remove the surplus trifluoroacetic anhydride and trifluoroacetic acid residues. The amount of the treated specific polyimide precursor is determined by a Nuclear Magnetic Resonance (NMR) method, whereby the amount of the terminal amino groups of the specific polyimide precursor is measured.

The number average molecular weight of the specific polyimide precursor is preferably from 1,000 to 100,000, more preferably from 5,000 to 50,000, and still more preferably from 10,000 to 30,000.

If the number average molecular weight of the specific polyimide precursor is within the above range, decrease in solubility of the specific polyimide precursor in a solvent is suppressed, and film formability is easily secured. Particularly, when the specific polyimide precursor having amino groups on the terminal thereof is used, as the molecular weight decreases, the terminal amino groups are present in a higher proportion. Accordingly, the solubility easily decreases due to the influence of the organic amine compound which also exists in the polyimide precursor composition. However, if the number average molecular weight of the specific polyimide precursor is within the above range, decrease in the solubility may be suppressed.

Moreover, if the molar equivalent ratio between the tetracarboxylic dianhydride and the diamine compound is adjusted, the specific polyimide precursor having a target number average molecular weight is obtained.

The number average molecular weight of the specific polyimide precursor is measured by Gel Permeation Chromatography (GPC) under the following measurement conditions.

Column: Tosoh TSKgelα-M (7.8 mm I.D×30 cm)

Eluent: dimethylformamide (DMF)/30 mM LiBr/60 mM phosphoric acid

Flow rate: 0.6 mL/min

Injection amount: 60 μL

Detector: RI (differential refractive index detector)

The content (concentration) of the specific polyimide precursor is preferably from 0.1% by weight to 40% by weight, more preferably from 0.5% by weight to 25% by weight, and still more preferably from 1% by weight to 20% by weight, based on the entire polyimide precursor composition.

Organic Amine Compound

The organic amine compound is a compound that increases solubility of the specific polyimide precursor (a carboxyl group thereof) in a solvent by making the precursor into an amine salt and functions as an imidization accelerator as well.

Moreover, the organic amine compound may be a water-soluble compound. Herein, the term “water-soluble” means that an object substance dissolves in an amount of 1% by weight or more in water at 25° C.

Examples of the organic amine compound include primary, secondary, and tertiary amine compounds.

Among these, the organic amine compound is preferably at least one kind (particularly, a tertiary amine compound) selected from secondary and tertiary amine compounds. If the tertiary or secondary amine compound is used as the organic amine compound, solubility of the specific polyimide precursor in a solvent easily increases, and the film formability is easily improved. In addition, solution stability of the polyimide precursor composition is easily improved.

Examples of the organic amine compound include monovalent amine compounds and polyvalent amine compounds having a valency of 2 or higher. If a polyvalent amine compound having a valency of 2 or higher is used, a pseudo-crosslinked structure is easily formed between molecules of the specific polyimide precursor, and solution stability of the polyimide precursor composition is easily improved.

Examples of the primary amine compound include methylamine, ethylamine, n-propylamine, isopropylamine, 2-ehtanolamine, 2-amino-2-methyl-1-propanol, and the like.

Examples of the secondary amine compound include dimethylamine, 2-(methylamino)ethanol, 2-(ethylamino)ethanol, morpholine, and the like.

Examples of the tertiary amine compound include 2-dimethylaminoethanol, 2-diethylaminoethanol, 2-dimethylaminopropanol, pyridine, triethylamine, picoline, methylmorpholine, ethylmorpholine, and the like.

Examples of the polyvalent amine compound include isoquinolines, pyrimidines, pyrazines, piperazines, triazines, polyaniline, polypyridine, polyamine, and the like.

Among these, the organic amine compound is preferably a compound having a boiling point of 60° C. or higher (more preferably from 60° C. to 200° C. and still more preferably from 70° C. to 150° C.). If the boiling point of the organic amine compound is 60° C. or higher, the organic amine compound is suppressed from volatilizing from the polyimide precursor composition during storage, and decrease in the solubility of the specific polyimide precursor in a solvent is easily suppressed.

The content of the organic amine compound is preferably from 50 mol % to 500 mol %, more preferably from 80 mol % to 250 mol %, and still more preferably from 100 mol % to 200 mol %, based on the carboxyl group contained in the specific polyimide precursor.

If the content of the organic amine compound is within the above range, solubility of the specific polyimide precursor in a solvent is easily increased, and the film formability is easily improved. Moreover, solution stability of the polyimide precursor composition is easily improved.

Solvent

As the solvent, a mixed solvent containing the specific organic solvents and water is used. As the specific organic solvents, one or more kinds of organic solvents selected from a water-soluble ether solvent, a water-soluble ketone solvent, and a water-soluble alcohol solvent are used. Herein, the term “water-soluble” means that an object substance dissolves in an amount of 1% by weight or more in water at 25° C.

As the combination for the mixed solvent, for example, a combination of an water-soluble ether solvent and water and a combination of an water-soluble ketone solvent and water are preferable.

One kind of the specific organic solvent may be used alone. However, when two or more kinds thereof are concurrently used, examples of the combination thereof include a combination of a water-soluble ether solvent and water-soluble alcohol solvent, a combination of a water-soluble ketone solvent and a water-soluble alcohol solvent, and a combination of a water-soluble ether solvent, a water-soluble ketone solvent, and a water-soluble alcohol solvent.

The water-soluble ether solvent is a water-soluble solvent having an ether bond in a molecule. Examples of the water-soluble ether solvent include THF, DOX, trioxane, 2-dimethoxyethane, diethylene glycol dimethyl ether, diethylene glycol diethyl ether, and the like. Among these, THE and DOX are preferable as the water-soluble ether solvent.

The water-soluble ketone solvent is a water-soluble solvent having a ketone group in a molecule. Examples of the water-soluble ketone solvent include acetone (hereinafter, described as ATN), methyl ethyl ketone(hereinafter, described as MEK), cyclohexanone, and the like. Among these, ATN is preferably as the water-soluble ketone solvent.

The water-soluble alcohol solvent is a water-soluble solvent having an alcoholic hydroxyl group in a molecule. Examples of the water-soluble alcohol solvent include methanol, ethanol, 1-propanol, 2-propanol, tert-butyl alcohol, ethylene glycol, 1,2-propanediol, 1,3-propanediol, 1,3-butanediol, 1,4-butanediol, 2,3-butanediol, 1,5-pentanedial, 2-butene-1,4-diol, 2-methyl-2,4-pentanedial, glycerin, 2-ethyl-2-hydroxymethyl-1,3-propanediol, 1,2,6-hexanetriol, and the like. Among these, methanol, ethanol, 2-propanol, and ethylene glycol are preferable as the water-soluble alcohol solvent.

The boiling point of the specific organic solvents is preferably 160° C. or lower, more preferably from 40° C. to 150° C., and still more preferably from 50° C. to 120° C. If the boiling point of the specific organic solvents is within the above range, the specific organic solvents do not easily remain in the polyimide-molded article, and a polyimide-molded article having a high mechanical strength is easily obtained.

Meanwhile, examples of water include distilled water, deionized water, ultra-filtered water, pure water, and the like.

The content of water is preferably from 30% by weight to 99.9% by weight, more preferably from 50% by weight to 99.9% by weight, and still more preferably from 80% by weight to 99.9% by weight, based on the entire solvent. In addition, the solvent contains the specific organic solvent as the rest that remains when water is excluded from the entire solvent.

If the content of water is within the above range, solubility of the specific polyimide precursor, which have turned into an amine salt, in the solvent increases, and the film formability is improved.

Herein, the range of solubility of the specific polyimide precursor in the solvent is controlled according to the content of water and the type and amount of the organic amine compound. Within a range in which the content of water is small, the specific polyimide precursor easily dissolves in a region where the amount of the organic amine compound added is small. Inversely, within a range in which the content of water is large, the specific polyimide precursor easily dissolves in a region where the amount of the organic amine compound added is large. Moreover, when the hydrophiicity is high for the reason that the organic amine compound contains a hydroxyl group or the like, the specific polyimide precursor easily dissolves in a region where the content of water is large.

Other Additives

The polyimide precursor composition according to the present exemplary embodiment may contain various fillers and the like, so as to impart conductivity or various functions such as a mechanical strength to the polyimide-molded article that is prepared using the composition. The polyimide precursor composition may also contain a catalyst for accelerating the imidization reaction, a leveling material for improving quality of the prepared film, and the like.

Examples of the conductive material added for imparting conductivity include conductive materials (having a volume resistivity of, for example, less than 10⁷ Ω·cm, the same shall be applied herein after) and semi-conductive materials (having a volume resistivity of, for example, 10⁷ Ω·cm to 10¹³ Ω·cm, the same shall be applied hereinafter), and the material is selected according to the purpose of use.

Examples of conductive agents include carbon black (for example, acidic carbon black having pH of 5.0 or less), metals (for example, aluminum and nickel), metal oxides (for example, yttrium oxide and tin oxide), ion conductive substances (for example, potassium titanate and LiCl), conductive polymers (for example, polyaniline, polypyrrole, polysulfone, and polyacetylene), and the like.

One kind of these conductive materials may be used alone, or two or more kinds thereof may be used concurrently.

Moreover, when the conductive material has a particle shape, the primary particle size thereof is preferably less than 10 μm, and more preferably 1 μm or less.

Examples of the filler added for enhancing the mechanical strength include materials having a particle shape, such as silica powder, alumina powder, barium sulfate powder, titanium oxide powder, mica, and talc. In addition, in order to improve water repellency or mold releasability of the surface of polyimide-molded article, fluorine resin powder such as polytetrafluoroethylene (PTFE) and a tetrafluoroethylene-perfluoroalkyl vinyl ether copolymer (PFA), and the like may be added.

As the catalyst for accelerating the imidization reaction, a dehydrating agent such as acid anhydride, an acid catalyst such as a phenol derivative, a sulfonic acid derivative, and a benzoic acid derivative, and the like may be used.

In order to improve the quality of the film prepared using the polyimide-molded article, a surfactant may be added. As the surfactant to be used, any of cationic, anionic, and nonionic surfactants may be used.

The content of other additives may be selected according to the purpose of use of the polyimide-molded article to be prepared.

Method for Preparing Polyimide Precursor Composition

The method for preparing a polyimide precursor composition according to the present exemplary embodiment includes a step (hereinafter, called a “polymerization step”) of forming a resin (hereinafter, called a “polyimide precursor”) by polymerizing a tetracarboxylic dianhydride and a diamine compound in a solvent which contains water and one or more kinds of organic solvents (hereinafter, called “specific organic solvents”) selected from a water-soluble ether solvent, a water-soluble ketone solvent, and a water-soluble alcohol solvent, and a step (hereinafter, called an “amine salt-making step”) of adding an organic amine compound to the solvent after the resin is formed. In addition, the method may optionally include a step (hereinafter, called a “solvent replacement step”) of replacing the solvent or changing the solvent composition, after the polymerization step.

In the method for preparing a polyimide precursor composition according to the exemplary embodiment, a polyimide precursor is formed in a solvent which does not contain a non-protonic polar solvent and contains the specific organic solvents and water, and then an organic amine compound is added to the solvent to make the polyimide precursor (a carboxyl group thereof) into an amine salt.

In the method for preparing a polyimide precursor composition according to the exemplary embodiment, a non-protonic polar solvent, which causes of decrease in the mechanical strength of the polyimide-molded article, is not used as a solvent. Moreover, after the polyimide precursor is formed, an organic amine compound is added thereto (the organic compound is not added in the polymerization step). Accordingly, hindrance in formation of the polyimide precursor (hindrance in the polymerization reaction) is suppressed by the organic amine compound.

Consequently, by the method for preparing a polyimide precursor composition according to the exemplary embodiment, a polyimide precursor composition from which a polyimide-molded article having a high mechanical strength is obtained is prepared.

In addition, by the method for preparing a polyimide precursor composition according to the exemplary embodiment, a polyimide precursor composition from which a polyimide-molded article excellent in various properties such as thermal resistance, electrical characteristics, and solvent resistance in addition to the mechanical strength is easily obtained is prepared.

Further, in the method for preparing a polyimide precursor composition according to the exemplary embodiment, a mixed solvent containing the specific organic solvents and water is used as a solvent. Accordingly, a polyimide precursor composition is prepared with high productivity. Particularly, it is not necessary to perform heating to an excessive degree to replace the solvent, and it is easy to suppress the formed polyimide precursor from undergoing thermal imidization.

Hereinafter, the respective steps of the method for preparing a polyimide precursor composition according to the present exemplary embodiment will be described. The respective materials to be used are the same as those described for the polyimide precursor composition according to the present exemplary embodiment as above, so the description thereof will not be repeated.

Polymerization Step

In the polymerization step, the tetracarboxylic dianhydride and the diamine compound are polymerized in a solvent containing the specific organic solvent and water to form a polyimide precursor.

The reaction temperature during the polymerization reaction of the polyimide precursor is, for example, preferably from 0° C. to 70° C., more preferably from 10° C. to 60° C., and still more preferably from 20° C. to 55° C. If the reaction temperature is controlled to be 0° C. or higher, the heat of reaction caused by the polymerization reaction is removed, and the progress of the polymerization reaction is accelerated. Accordingly, the time taken for the reaction is shortened, and the productivity is easily improved. On the other hand, if the reaction temperature is controlled to be 70° C. or less, the progress of the imidization reaction caused in the molecule of the formed polyimide precursor is suppressed. Accordingly, precipitation or gelation caused by the decrease in the solubility of the polyimide precursor is easily suppressed.

In addition, the time of the polymerization reaction of the polyimide precursor is preferably within a range of 1 hour to 24 hours according to the reaction temperature.

Herein, the mixing ratio (weight ratio) between the specific organic solvent and water in the polymerization step is preferably a ratio in which the weight of water is smaller than that of the specific organic solvent, in the respect that the progress of the polymerization reaction is not hindered. The ratio is preferably, for example, 98:2 to 70:30 and more preferably 90:10 to 80:20.

Specifically, in the case of a combination of the water-soluble ether solvent and water, the mixing ratio (weight ratio) is preferably 96:4 to 70:30 and more preferably 90:10 to 80:20, and in the case of a combination of the water-soluble ketone solvent and water, the mixing ratio is preferably 90:10 to 75:25 and more preferably 90:10 to 80:20.

Amine Salt-Making Step

In the amine salt-making step, after the polyimide precursor is formed, an organic amine compound is added to the solvent to make the polyimide precursor (a carboxyl group thereof) into an amine salt. In this manner, solubility of the polyimide precursor in the solvent is increased.

In the amine salt-making step, water as a solvent may be added.

Solvent Replacement Step

The solvent replacement step is performed for the purpose of, for example, stabilizing the polyimide precursor composition prepared, adjusting the dissolution or solid content concentration of the polyimide precursor formed, and the like by changing the solvent composition in the solution obtained after the polyimide precursor is formed.

The solvent replacement step is performed by adding water and other solvents or by removing the target solvent. Examples of the solvent removal method include a method of distilling away the solvent by performing heating and pressure reduction (distillation method), a reprecipitation method in which water is added to precipitate the polyimide precursor and then the solvent is separated and removed. The removal of solvent may be performed by combining the distillation method with the reprecipitation method.

Either the solvent replacement step (or solvent composition-changing step) or the amine-salt making step may be performed first. Moreover, both the steps may be performed concurrently.

In addition, the solvent replacement step is an optional step that may not be performed if the solvent composition in the solvent obtained after the polyimide precursor is formed does not need to be changed.

When the solvent replacement step is performed, in the amine salt-making step, it is preferable to perform the following first or second amine salt-making step.

First Amine Salt-Making Step

In a first amine salt-making step, water is added to the solvent after the polyimide precursor is formed, the polyimide precursor is separated from the solvent, and water and an organic amine compound are added to the rest in which a portion of the solvent obtained after the separation is removed.

Specifically, for example, in the first amine salt-making step, when an excess amount of water is added to the solvent after the polyimide precursor is formed, the polyimide precursor is precipitated since the solubility thereof decreases, and as a result, the polyimide precursor is separated from the solvent. The amount of water added to the solvent is preferably, for example, from 10% by weight to 300% by weight, more preferably from 50% by weight to 200% by weight, based on the entire solvent.

When the polyimide precursor is separated from the solvent, the polyimide precursor is precipitated, and the supernatant becomes a solvent. If the supernatant liquid is removed, a portion of the solvent obtained after the separation is removed. The removal of a portion of the solvent may be removed not only by the removal of the supernatant liquid but also by filtration or the like.

In addition, if an organic amine compound (for example, an aqueous solution in which an organic amine compound has dissolved) is added to the rest together with water to be a solvent, the solvent is replaced, and the polyimide precursor (a carboxyl group thereof) turns into an amine salt.

If the first amine salt-making step is performed, a polyimide precursor composition having high purity is easily obtained.

Second Amnie Salt-Making Step

In a second amine salt-making step, after the polyimide precursor is formed, an organic amine salt is added to the rest remaining after a portion of the solvent distilled away or added to the rest while a portion of the solvent is being distilled away.

Specifically, for example, in the second amine salt-making step, after the polyimide precursor is formed, a portion of the solvent is removed by heating or pressure reduction. By the distillation of solvent, the specific organic solvents are mainly distilled away. Moreover, if an organic amine salt is added after the solvent is distilled away or added while a portion of the solvent is being distilled away, the solvent composition changes, and the polyimide precursor (a carboxyl group thereof) turns into an amine salt. When the organic amine compound is added, water may also be added as a solvent.

If the second amine salt-making step is performed, a polyimide precursor composition having undergone solvent replacement is easily obtained by a simple step without causing precipitation or the like of the polyimide precursor.

Example of Use of Polyimide Precursor Composition

The polyimide precursor composition according to the present exemplary embodiment is used as a coating liquid for forming a polyimide-molded article. Examples of the coating liquid for forming a polyimide-molded article include a coating liquid for forming polyimide film, a coating liquid for forming polyimide coat, and the like.

Examples of the polyimide film as a polyimide-molded article include flexible electronic substrate films, copper-clad laminate films, laminate films, electrical insulation films, porous films for fuel cells, separation films, and the like.

The polyimide coat as a polyimide-molded article include insulation coat, thermostable coat, an IC package, adhesive films, a liquid crystal alignment layer, resist films, planarizing films, microlens array films, insulation covering films, wire cover films, optical fiber cover films, and the like.

Examples of other polyimide-molded articles include belt members, and examples of belt members include a driving belt, belts for electrophotographic image forming apparatuses (for example, an intermediate belt, a transfer belt, a fixing belt, and a transport belt), and the like.

Method for Preparing Polyimide-Molded Article

The polyimide precursor composition according to the present exemplary embodiment is coated onto an object to be coated, and the coating film formed in this manner is subjected to heating treatment, thereby obtaining a polyimide-molded article.

The polyimide-molded article prepared using the polyimide precursor composition is not particularly limited. Hereinafter, as an example of a method for preparing a polyimide-molded article by using the polyimide precursor composition according to the present exemplary embodiment, a method for preparing an endless belt will be described in detail.

The method for preparing a polyimide-molded article by using the polyimide precursor composition according to the present exemplary embodiment includes a step of forming a coating film by coating the polyimide precursor composition according to the present exemplary embodiment on an object to be coated, a step of forming an endless belt by performing heating treatment on the coating film formed on the object to be coated, and a step of detaching the endless belt from the objected to be coated.

First, the polyimide precursor composition according to the present exemplary embodiment is coated onto the inner or outer surface of a mold. As the mold, for example, a cylindrical metal mold is preferably used. Instead of the metal mold, molding tools made of other materials such as a resin, glass, and ceramic may be used. Moreover, the surface of the molding tool may be coated with glass or ceramic, or a release agent based on silicone or fluorine may be used.

Thereafter, the cylindrical metal mold coated with the polyimide precursor composition is dried by being heated or being placed in a vacuum environment so as to volatilize 30% by weight or more, preferably 50% by weight or more of the solvent contained.

Subsequently, the dried film is subjected to imidization treatment, and as a result, a polyimide resin layer is formed.

In the imidization treatment, heating is performed under the condition of, for example, 150° C. to 400° C. (preferably from 200° C. to 300° C.) for 20 minutes to 60 minutes. In this manner, an imidization reaction occurs, and the polyimide resin layer is formed. During the heating reaction, heating is preferably performed by raising the temperature stepwise or slowly at a constant rate, before it reaches a final heating temperature. The temperature of imidization varies with, for example, the type of the tetracarboxylic dianhydride and diamine used as raw materials. If the degree of imidization is insufficient, the mechanical strength and electrical characteristics deteriorate. Therefore, the temperature is set such that the imidization is completed.

Thereafter, the cylindrical film formed on the surface of the cylindrical metal mold is detached to obtain an endless belt.

Polyimide-Molded Article

The polyimide-molded article formed of the polyimide precursor composition according to the present exemplary embodiment contains an organic amine compound and specific organic solvents (one or more kinds of organic solvents selected from a water-soluble ether solvent, a water-soluble ketone solvent, and a water-soluble alcohol solvent) contained in the polyimide precursor composition.

The amount of the specific organic solvents (a water-soluble ether solvent, a water-soluble ketone solvent, and a water-soluble alcohol solvent) contained in the polyimide-molded article formed of the polyimide precursor composition according to the present exemplary embodiment is 1 ppb or more and less than 1% in the polyimide-molded article. The amount of the specific organic solvents contained in the polyimide-molded article is determined by heating the polyimide-molded article and performing gas chromatography on the content of gas generated. Likewise, the amount of the organic amine compound contained in the polyimide-molded article is also determined by heating the polyimide-molded article and performing gas chromatography on the content of gas generated.

### EXAMPLES

Hereinafter, examples will be described, but the present invention is not limited to these examples. Moreover, unless otherwise specified, both the “part(s)” and “%” are based on weight.

### Example 1

### Preparation of Polyimide Precursor Compositions (A-1) and (A-2)

Polymerization Step

360 g of THF and 40 g of water are filled in a flask equipped with a stirring rod, a thermometer, and a dropping funnel, and 41.23 g (205.92 mmol) of 4,4′-diaminodiphenylether (hereinafter, described as ODA: a molecular weight of 200.24) is added thereto under a flow of dried nitrogen gas. The mixture is stirred while the solution temperature is being kept at 30° C., and 58.77 g (199.75 mmol) of 3,3′,4,4′-biphenyltetracarboxylic dianhydride (hereinafter described as BPDA: a molecular weight of 294.22) is slowly added thereto. The dissolution of the diamine compound and tetracarboxylic dianhydride is confirmed, and then the mixture is further reacted for 24 hours while the reaction temperature is being kept at 30° C. The viscosity of the polyimide precursor solution (solid content of 20% by weight) that is measured by the method described later is 150 Pa·s.

In addition, the imidization rate of the formed polyimide precursor is 0.02, and as a result of measuring the amount of the terminal amino groups thereof as described above, all of the terminals are confirmed to have an amino group.

Amine Salt-Making Step

35.62 g (399.5 mmol) of dimethylaminoethanol (hereinafter, described as DMAEt: a molecular weight of 89.14) and 400 g of water are added to the polyimide precursor solution obtained in the polymerization step under stirring. As a result, an aqueous polyimide precursor solution in which the polyimide precursor has dissolved in water by being made into an amine salt is obtained.

The obtained aqueous polyimide precursor solution is named a polyimide precursor composition (A-1). The obtained polyimide precursor composition (A-1) is composed as follows.

Composition of Polyimide Precursor Composition (A-1)

Solid content: 10% (proportion of solid content as polyimide)

Compositional ratio between solvents: THF/water=360 g/440 g

Solvent Replacement Step

The pressure of the obtained aqueous polyimide precursor solution is reduced to 10 mm Hg at 30° C. under stirring to remove a portion of THF, thereby obtaining a polyimide precursor composition (A-2) composed as below.

Composition of Polyimide Precursor Composition (A-2)

Viscosity: 148 Pa·s

Solid content: 18.0% (proportion of solid content as polyimide)

Compositional Ratio Between Solvents: THF/Water=6/94

The respective measurements are performed as below.

Method of Viscosity Measurement

The viscosity is measured using an E-type viscometer under the following conditions.

Measurement instrument: E-type rotating viscometer TV-20H (TOKI SANGYO CO., LTD.)

Measurement probe: No. 3-type rotor 3°×R14

Measurement temperature: 22° C.

Method of Solid Content Measurement

The solid content is measured using a thermal gravity/differential thermal analyzer under the following conditions. The value measured at 380° C. is used, and the solid content is measured as a proportion of the solid content as polyimide.

Measurement instrument: thermal gravity/differential thermal analyzer TG/DTA 6200 (Seiko Instruments Inc.)

Measurement range: 20° C. to 400° C.

Rate of temperature increase: 20° C./min

Composition of Solvent and Moisture Content in Solvent

By using an automatic moisture analyzer that uses coulometric titration (Karl Fischer), the moisture content in the polyimide precursor composition is measured under the following conditions. From the measured value, the content of resin contained in the sample is subtracted to calculate the moisture content in the solvent. In this manner, the composition of the solvent is analyzed.

Measurement instrument: CA-07 model (Mitsubishi Chemical Corporation) as an automatic moisture analyzer using coulometric titration (Karl Fischer)

Sample amount: 10 μl

Evaluation

The obtained polyimide precursor compositions (A-1) and (A-2) are used to prepare films, and the film formability thereof is evaluated. Moreover, mechanical properties (tensile strength and tensile elongation) of the prepared films are measured.

Film Formability

The polyimide precursor composition (A-1) is used to prepare a film by the following operation. The prepared film is evaluated in terms of (1) void mark and (2) surface unevenness/pattern.

Coating method: bar coating method using a coating blade equipped with a spacer to yield a coating thickness of 100 μm

Coating substrate: 1.1 mint glass plate

Drying temperature: 60° C.×10 minutes

Baking temperature: 250° C.×30 minutes

(1) Void Mark

The prepared film is evaluated to confirm whether there is a void mark on the surface of the film. The evaluation criteria are as follows.

A: No void mark is found.

B: It is possible to confirm 1 or more and less than 10 void marks on the surface of the prepared film.

C: There are 10 or more and less than 50 void marks scattered on the surface of the prepared film.

D: Numerous void marks are evenly caused on the surface of the prepared film.

(2) Surface Unevenness/Pattern

The prepared film is evaluated to confirm whether surface unevenness and patterns are caused on the surface of the prepared film. The evaluation criteria are as follows.

A: Surface unevenness and patterns are not found.

B: It is possible to confirm surface unevenness and patterns to a slight extent in a portion of the surface of prepared film (less than 10% of the surface area of the prepared film).

C: It is possible to confirm surface unevenness and patterns in a portion of the surface of the prepared film.

D: Surface unevenness and patterns are evenly caused on the surface of the prepared film (10% or more of the surface area of the prepared film).

Tensile Strength/Elongation

From the prepared film, a piece of sample is molded by punching by using a No. 3 dumbbell. The piece of sample is installed in a tensile tester, and under the following conditions, an applied load (tensile strength) at which the sample undergoes tensile breaking and elongation at break (tensile elongation) are measured.

Measurement instrument: A tensile tester 1605 model manufactured by AIKOH ENGINEERING CO., LTD.

Sample length: 30 mm

Sample width: 5 mm

Tensile rate: 10 mm/min

### Examples 2 to 13

### Preparation of Polyimide Precursor Compositions (A-3) to (A-8) and (B-1) to (D-2)

Polyimide precursor compositions (A-3) to (A-8) and (B-1) to (D-2) are prepared in the same manner as in Example 1, except that the conditions of the polymerization step, amine salt-making step, and solvent replacement step are changed according to Tables 1 to 2. Here, the solvent replacement step is performed such that the viscosity, solid content, and moisture content in the solvent as shown in Tables 1 and 2 are obtained.

Moreover, films are prepared and evaluated in the same manner as in Example 1, and the evaluation results are shown in Tables 1 and 2.

The amount of the terminal amino group in the polyimide precursor prepared in Example 7 is measured as above. As a result, it is confirmed that none of the terminals contain an amino group, and all of the terminals have a carboxyl group.

### Example 14

### Precipitation Method

### Preparation of Polyimide Precursor Composition (E-1)

Water with a volume 10 times greater than that of the solvent of the composition is added to the polyimide precursor solution prepared in the polymerization step in Example 1, thereby reprecipitating the polyimide precursor. Thereafter, the supernatant liquid thereof is removed.

Subsequently, 106.86 g (1198.5 mmol) of DMAEt and 900 g of water are added to the rest thereof such that a treatment rate becomes 300 mol %. In this manner, an aqueous polyimide precursor solution in which the polyimide precursor has dissolved in water by being made into an amine salt is obtained.

The obtained aqueous polyimide precursor solution is named a polyimide precursor composition (E-1). The obtained polyimide precursor composition (E-1) is composed as follows.

Composition of Polyimide Precursor Composition (E-1)

Viscosity: 60 Pa·s

Solid content: 9.0% (proportion of solid content as polyimide)

Compositional ratio between solvents: THF/water=2/98

Imidization rate: 0.02

The obtained polyimide precursor composition (E-1) is used to prepare a film in the same manner as in Example 1, and the film is evaluated. The evaluation results are shown in Table 2.

### Example 15

### Reprecipitation Method

### Preparation of Polyimide Precursor Composition (E-2)

A polyimide precursor composition (E-2) is prepared in the same manner as in Example 14, except that 89.05 g (998.75 mmol) of DMAEt and 900 g of water are added to the rest remaining after removing the supernatant liquid such that a treatment rate becomes 250 mol %. The obtained polyimide precursor composition (E-2) is composed as follows.

Composition of Polyimide Precursor Composition (E-2)

Viscosity: 55 Pa·s

Solid content: 9.0% (proportion of solid content as polyimide)

Compositional ratio between solvents: THF/water=2/98

Imidization rate: 0.02

The obtained polyimide precursor composition (E-2) is used to prepare a film in the same manner as in Example 1, and the film is evaluated. The evaluation results are shown in Table 2.

### Example 16

### Reprecipitation Method

### Preparation of Polyimide Precursor Composition (E-3)

A polyimide precursor composition (E-3) is prepared in the same manner as in Example 14, except that 71.24 g (799.0 mmol) of DMAEt and 900 g of water are added to the rest remaining after removing the supernatant liquid such that a treatment rate becomes 200 mol %. The obtained polyimide precursor composition (E-3) is composed as follows.

Composition of polyimide precursor composition (E-3)

Viscosity: 50 Pa·s

Solid content: 9.0% (proportion of solid content as polyimide)

Compositional ratio between solvents: THF/water=2/98

Imidization rate: 0.02

The obtained polyimide precursor composition (E-3) is used to prepare a film in the same manner as in Example 1, and the film is evaluated. The evaluation results are shown in Table 2.

### Example 17

### Distillation Method

### Preparation of Polyimide Precursor Composition (F-1)

The pressure of the polyimide precursor solution prepared in the polymerization step of Example 1 is reduced to 10 mmHg at 30° C. under stirring to distill away a portion of THF.

Thereafter, while a portion THF is being distilled away, 106.86 g (1198.5 mmol) of DMAEt and 900 g of water are added thereto such that a treatment rate becomes 300 mol %. In this manner, an aqueous polyimide precursor solution in which the polyimide precursor has dissolved in water by being made into an amine salt is obtained.

Subsequently, after distillation ends, an aqueous polyimide precursor solution in which the polyimide precursor has dissolved in water by being made into an amine salt is obtained.

The obtained aqueous polyimide precursor solution is named a polyimide precursor composition (F-1). The obtained polyimide precursor composition (F-1) is composed as follows.

Composition of Polyimide Precursor Composition (F-1)

Viscosity: 80 Pa·s

Solid content: 12% (proportion of solid content as polyimide)

Compositional ratio between solvents: THF/water=30/70

Imidization rate: 0.08

The obtained polyimide precursor composition (F-1) is used to prepare a film in the same manner as in Example 1, and the film is evaluated. The evaluation results are shown in Table 2.

### Example 18

### Distillation Method

### Preparation of Polyimide Precursor Composition (F-2)

A polyimide precursor composition (F-2) is prepared in the same manner as in Example 17, except that while a portion of THF is being distilled away, 89.05 g (998.75 mmol) of DMAEt and 900 g of water are added such that a treatment rate becomes 250 mol %. The obtained polyimide precursor composition (F-2) is composed as follows.

Composition of Polyimide Precursor Composition (F-2)

Viscosity: 70 Pa·s

Solid content: 9.0% (proportion of solid content as polyimide)

Compositional ratio between solvents: THF/water=20/80

Imidization rate: 0.08

The obtained polyimide precursor composition (F-2) is used to prepare a film in the same manner as in Example 1, and the film is evaluated. The evaluation results are shown in Table 2.

### Example 19

### Distillation Method

### Preparation of Polyimide Precursor Composition (F-3)

A polyimide precursor composition (F-3) is prepared in the same manner as in Example 17, except that while a portion of THF is being distilled away, 71.24 g (799.0 mmol) of DMAEt and 900 g of water are added such that a treatment rate becomes 200 mol %. The obtained polyimide precursor composition (F-3) is composed as follows.

Composition of polyimide precursor composition (F-3)

Viscosity: 60 Pa·s

Solid content: 9.0% (proportion of solid content as polyimide)

Compositional ratio between solvents: THF/water=15/85

Imidization rate: 0.06

The obtained polyimide precursor composition (F-3) is used to prepare a film in the same manner as in Example 1, and the film is evaluated. The evaluation results are shown in Table 2.

### Examples 20 to 25

### Preparation of Polyimide Precursor Compositions (G-1) and (G-2), (H-1) and (H-2), and (I-1) and (I-2)

Polyimide precursor compositions (G-1) and (G-2), (H-1) and (H-2), and (I-1) and (I-2) are prepared in the same manner as in Example 1, except that the conditions of the polymerization step, amine salt-making step, and solvent replacement step are changed according to Table 3. Here, the solvent replacement step is performed such that the viscosity, solid content, and moisture content in the solvent shown in Table 3 are obtained.

Thereafter, films are prepared in the same manner as in Example 1 and evaluated. The evaluation results are shown in Table 3.

### Example 26

### Preparation of Polyimide Precursor Composition (J-1)

A polyimide precursor composition (J-1) is prepared in the same manner as in Example 1, except that the reaction temperature in the polymerization step is set to 60° C. The imidization rate of the obtained polyimide precursor is 0.18.

The obtained polyimide precursor composition (J-1) is used to prepare a film in the same manner as in Example 1, and the film is evaluated. The evaluation results are shown in Table 3.

### Example 27

### Preparation of Polyimide Precursor Composition (J-2)

A polyimide precursor composition (J-2) is prepared in the same manner as in Example 1, except that the reaction temperature in the polymerization step is set to 50° C. The imidization rate of the obtained polyimide precursor is 0.13.

The obtained polyimide precursor composition (J-2) is used to prepare a film in the same manner as in Example-1, and the film is evaluated. The evaluation results are shown in Table 3.

### Comparative Example 1

### Preparation of Polyimide Precursor Composition (X-1)

400 g of N-methyl-2-pyrrolidone (hereinafter, described as NMP) is filled in a flask equipped with a stirring rod, a thermometer, and a dropping funnel, and 41.23 g (205.92 mmol) of 4,4′-daminodiphenylether (hereinafter, described as ODA: a molecular weight of 200.24) is added thereto under a flow of dried nitrogen gas. While the solution temperature is being kept at 30° C., 58.77 g (199.75 mmol) of 3,3′4,4′-biphenyltetracarboxylic dianhydride (hereinafter, described as BPDA: a molecular weight of 294.22) is slowly added thereto under stirring. The dissolution of the diamine compound and tetracarboxylic dianhydride is confirmed, and then the mixture is further reacted for 24 hours while the reaction temperature is being kept at 30° C. The viscosity of the polyimide precursor solution (solid content of 20% by weight) is measured to be 120 Pa·s.

The obtained polyimide precursor solution is named a polyimide precursor composition (X-1).

The obtained polyimide precursor composition (X-1) is used to prepare a film in the same manner as in Example 1, and the film is evaluated. The evaluation results are shown in Table 4.

As a result, when the baking temperature thereof is set to 250° C. as in Example 1, NMP remains in the film. Accordingly, the degree of both the tensile strength and tensile elongation is lowered compared to Example 1. As one of the reason, it is considered that NMP with a high boiling point contained in the polyimide precursor composition (X-1) remains in the prepared film, whereby the mechanical strength is reduced.

### Comparative Example 2

### Preparation of Polyimide Precursor Composition (X-2)

The polyimide precursor composition (X-1) prepared in Comparative example 1 is added to acetone having a volume 10 times greater than that of the composition, thereby reprecipitating the polyimide precursor. The polyimide precursor is filtered and then dried for 24 hours at 40° C. under a reduced pressure (10 mmHg). After drying, 200 g of water and 18.03 g (202.20 mmol) of dimethylaminoehtanol are added to 50 g of the polyimide precursor (101.10 mmol equivalent of a carboxyl group), and the mixture is dissolved under stirring for 6 hours at 25° C., thereby obtaining a polyimide precursor composition (X-2).

The obtained polyimide precursor composition (X-2) is used to prepare a film in the same manner as in Example 1, and the film is evaluated. The results are shown in Table 4.

As a result, the film formability thereof is confirmed to be excellent similarly to Example 1. As a result of a tensile test, both the tensile strength and tensile elongation thereof are confirmed to be poor than that of Example 1.

The content of NMP remaining in the polyimide precursor composition (X-2) is analyzed by liquid chromatography. As a result, the content is measured to be 6% by weight in the solvent. It is considered because the tensile properties of the sample formed into a film by using the polyimide precursor composition (X-2), NMP remains in the formed film just like Comparative example 1.

### Comparative Example 3

### Preparation of Polyimide Precursor Composition (X-3)

During the polymerization step in Comparative example 1, an organic amine compound is added to perform polymerization in the following manner.

400 g of NMP is filled in a flask equipped with a stirring rod, a thermometer, and a dropping funnel, and 41.23 g (205.92 mmol) of ODA and 35.62 g (399.5 mmol) of DMEAt are added thereto under stirring. While the solution temperature is being kept at 30° C., 58.77 g (199.75 mmol) of BPDA is slowly added thereto. The dissolution of the diamine compound and tetracarboxylic dianhydride is confirmed, and then the mixture is further reacted for 24 hours while the reaction temperature is being kept at 30° C. The viscosity of the polyimide precursor solution (solid content of 20% by weight) is measured to be 5 Pa·s.

The obtained polyimide precursor solution is named a polyimide precursor composition (X-3).

The obtained polyimide precursor composition (X-3) is used to prepare a film in the same manner as in Example 1, and the film is evaluated. The evaluation results are shown in Table 4.

### Comparative Example 4

### Preparation of Polyimide Precursor Composition (X-4)

A polyimide precursor composition (X-4) is prepared in the same manner as in Example 1, except that the reaction temperature is set to 60° C. and the reaction time is set to 48 hours in the polymerization step. At this time, a polyimide precursor resin is precipitated. Accordingly, the polyimide precursor composition (X-4) is not usable as a coating liquid. The imidization rate of the obtained polyimide precursor is 0.22.

### Comparative Example 5

### Preparation of Polyimide Precursor Composition (X-5)

A polyimide precursor composition (X-5) is prepared in the same manner as in Example 1, except that the amount of DMAEt added in the amine salt-making step is changed such that the treatment rate becomes 40 mol %. At this time, a polyimide precursor resin is precipitated. Accordingly, the polyimide precursor composition (X-5) is not usable as a coating liquid.

### Comparative Example 6

### Preparation of Polyimide Precursor Composition (X-6)

A polyimide precursor composition (X-6) is obtained in the same manner as in Example 1, except that 150 g of THF and 150 g of water are used as a solvent to be added in the amine salt-making step, and distillation of THF is completed at the point in time when the moisture content in the solvent becomes 25% in the solvent replacement step.

The obtained polyimide precursor composition (X-6) is used to prepare a film in the same manner as in Example 1, and the film is evaluated. The evaluation results are shown in Table 4.

As a result, the polyimide precursor having turned into an amine salt dissolves in the obtained polyimide precursor composition (X-6). In addition, when the composition is used as a coating liquid, a uniform coating film fails to be obtained, and the mechanical properties of the prepared film are poor.

### Comparative Example 7

### Preparation of Polyimide Precursor Composition (X-7)

A polyimide precursor composition (X-7) is obtained in the same manner as in Example 1, except that the amount of DMAEt added in the amine salt-making step is changed such that the treatment rate becomes 520 mol %.

The obtained polyimide precursor composition (X-7) is used to prepare a film in the same manner as in Example 1, and the film is evaluated. The evaluation results are shown in Table 4.

A portion of the obtained polyimide precursor composition (X-7) has turned into gel. Moreover, when being stored for 24 hours under the condition of room temperature, the obtained polyimide precursor composition (X-7) is thickened and turns into gel after 72 hours. Accordingly, the composition is not usable as a collating liquid.

TABLE 1

| Example/Comparative example | | | Example 1 | | Example 2 | Example 3 | Example 4 |
|---|---|---|---|---|---|---|---|
| Polyimide precursor composition | | | A-1 | A-2 | A-3 | A-4 | A-5 |
| Polymeriza- | Tetracarboxylic | Chemical | BPDA | BPDA | BPDA | BPDA | BPDA |
| tion step | dianhydride | species | | | | | |
| | | g | 58.77 | 58.77 | 58.77 | 58.77 | 58.77 |
| | | mmol | 199.75 | 199.75 | 199.75 | 199.75 | 199.75 |
| | Diamine | Chemical | ODA | ODA | ODA | ODA | ODA |
| | compound | species | | | | | |
| | | g | 41.23 | 41.23 | 41.23 | 41.23 | 41.23 |
| | | mmol | 205.92 | 205.92 | 205.92 | 205.92 | 205.92 |
| | Tetracarboxylic dianhydride/diamine | | 0.98 | 0.98 | 0.98 | 0.98 | 0.98 |
| | compound (molar ratio) | | | | | | |
| | Solvent 1 | Chemical | THF | THF | THF | THF | THF |
| | | species | | | | | |
| | | g | 360 | 360 | 360 | 360 | 360 |
| | Solvent 2 | Chemical | Water | Water | Water | Water | Water |
| | | species | | | | | |
| | | g | 40 | 40 | 40 | 40 | 40 |

| | | | | | |
|---|---|---|---|---|---|
| Solvent 1/solvent 2 | 9/1 | 9/1 | 9/1 | 9/1 | 9/1 |

| | State of liquid | | Homogeneously | Homogeneously | Homogeneously | Homogeneously | Homogeneously |
|---|---|---|---|---|---|---|---|
| | | | dissolved | dissolved | dissolved | dissolved | dissolved |
| | Imidization rate | | 0.02 | 0.02 | 0.02 | 0.02 | 0.02 |
| | Molecular weight | Mn | 20,000 | 20,000 | 20,000 | 20,000 | 20,000 |
| | Solid content | % | 20 | 20 | 20 | 20 | 20 |
| | Viscosity | Pa · s | 150 | 150 | 150 | 150 | 150 |
| Amine | Organic amine | Chemical | DMAEt | DMAEt | DMAEt | DMAEt | DMAEt |
| salt-making | compound | species | | | | | |
| step | | g | 35.62 | 35.62 | 17.82 | 28.5 | 42.74 |
| | | mmol | 399.5 | 399.5 | 199.76 | 319.6 | 479.4 |
| | Added solvent | Chemical | Water | Water | Water | Water | Water |
| | | species | | | | | |
| | | g | 400 | 400 | 400 | 400 | 400 |
| | Treatment rate | Mol % | 100 | 100 | 50 | 80 | 120 |

| | State of liquid | | Homogeneously | Homogeneously | Homogeneously | Homogeneously | Homogeneously |
|---|---|---|---|---|---|---|---|
| | | | dissolved | dissolved | dissolved | dissolved | dissolved |
| Solvent | State of liquid | | — | Homogeneously | Homogeneously | Homogeneously | Homogeneously |
| replacement | | | | dissolved | dissolved | dissolved | dissolved |
| step | Solid content | % | — | 18 | 18 | 18 | 18 |
| | Viscosity | Pa · s | — | 148 | 80 | 100 | 140 |
| | Moisture content in solvent | % | — | 94 | 98 | 82 | 86 |
| Film | Void mark | | A | A | A | A | A |
| formability | Surface unevenness/pattern | | A | A | A | A | A |
| Mechanical | Tensile strength | Mpa | 190 | 190 | 190 | 190 | 190 |
| properties | Tensile elongation | % | 80 | 80 | 80 | 80 | 80 |

| Example/Comparative example | | | Example 5 | Example 6 | Example 7 | Example 8 | Example 9 |
|---|---|---|---|---|---|---|---|
| Polyimide precursor composition | | | A-6 | A-7 | A-8 | B-1 | C-1 |
| Polymeriza- | Tetracarboxylic | Chemical | BPDA | BPDA | BPDA | BPDA | BPDA |
| tion step | dianhydride | species | | | | | |
| | | g | 58.77 | 58.77 | 58.77 | 58.77 | 58.77 |
| | | mmol | 199.75 | 199.75 | 199.75 | 199.75 | 199.75 |
| | Diamine | Chemical | ODA | ODA | ODA | ODA | ODA |
| | compound | species | | | | | |
| | | g | 41.23 | 41.23 | 41.23 | 41.23 | 41.23 |
| | | mmol | 205.92 | 205.92 | 205.92 | 205.92 | 205.92 |
| | Tetracarboxylic dianhydride/diamine | | 0.98 | 0.98 | 0.98 | 0.98 | 0.98 |
| | compound (molar ratio) | | | | | | |
| | Solvent 1 | Chemical | THF | THF | THF | THF | THF |
| | | species | | | | | |
| | | g | 360 | 360 | 360 | 360 | 360 |
| | Solvent 2 | Chemical | Water | Water | Water | Water | Water |
| | | species | | | | | |
| | | g | 40 | 40 | 40 | 40 | 40 |

| | | | | | |
|---|---|---|---|---|---|
| Solvent 1/solvent 2 | 9/1 | 9/1 | 9/1 | 9/1 | 9/1 |

| | State of liquid | | Homogeneously | Homogeneously | Homogeneously | Homogeneously | Homogeneously |
|---|---|---|---|---|---|---|---|
| | | | dissolved | dissolved | dissolved | dissolved | dissolved |
| | Imidization rate | | 0.02 | 0.02 | 0.02 | 0.02 | 0.02 |
| | Molecular weight | Mn | 20,000 | 20,000 | 20,000 | 20,000 | 20,000 |
| | Solid content | % | 20 | 20 | 20 | 20 | 20 |
| | Viscosity | Pa · s | 150 | 150 | 150 | 150 | 150 |
| Amine | Organic amine | Chemical | DMAEt | DMAEt | DMAEt | DMAEt | γ-Pyc |
| salt-making | compound | species | | | | | |
| step | | g | 71.24 | 89.05 | 178.1 | 17.81 | 58.08 |
| | | mmol | 799 | 998.75 | 1997.5 | 199.75 | 399.5 |
| | Added solvent | Chemical | Water | Water | Water | Water | Water |
| | | species | | | | | |
| | | g | 400 | 400 | 400 | 300 | 400 |
| | Treatment rate | Mol % | 200 | 250 | 500 | 50 | 100 |

| | State of liquid | | Homogeneously | Homogeneously | Homogeneously | Homogeneously | Homogeneously |
|---|---|---|---|---|---|---|---|
| | | | dissolved | dissolved | dissolved | dissolved | dissolved |
| Solvent | State of liquid | | Homogeneously | Homogeneously | Homogeneously | Homogeneously | Homogeneously |
| replacement | | | dissolved | dissolved | dissolved | dissolved | dissolved |
| step | Solid content | % | 18 | 18 | 18 | 14 | 18 |
| | Viscosity | Pa · s | 120 | 100 | 80 | 120 | 150 |
| | Moisture content in solvent | % | 94 | 98 | 88 | 50 | 92 |
| Film | Void mark | | A | A | A | A | A |
| formability | Surface unevenness/pattern | | A | A | A | A | A |
| Mechanical | Tensile strength | Mpa | 190 | 190 | 190 | 190 | 190 |
| properties | Tensile elongation | % | 80 | 80 | 80 | 80 | 80 |

TABLE 2

| Example/Comparative example | | | Example 10 | Example 11 | Example 12 | Example 13 | Example 14 |
|---|---|---|---|---|---|---|---|
| Polyimide precursor composition | | | C-2 | C-3 | D-1 | D-2 | E-1 |
| Polymeriza- | Tetracarboxylic | Chemical | BPDA | BPDA | BPDA | BPDA | BPDA |
| tion step | dianhydride | species | | | | | |
| | | g | 58.77 | 58.77 | 58.77 | 58.77 | 58.77 |
| | | mmol | 199.75 | 199.75 | 199.75 | 199.75 | 199.75 |
| | Diamine | Chemical | ODA | ODA | ODA | ODA | ODA |
| | compound | species | | | | | |
| | | g | 41.23 | 41.23 | 41.23 | 41.23 | 41.23 |
| | | mmol | 205.92 | 205.92 | 205.92 | 205.92 | 205.92 |
| | Tetracarboxylic dianhydride/diamine | | 0.98 | 0.98 | 0.98 | 0.98 | 0.98 |
| | compound (molar ratio) | | | | | | |
| | Solvent 1 | Chemical | THF | THF | DOX | ATN | THF |
| | | species | | | | | |
| | | g | 360 | 360 | 360 | 360 | 360 |
| | Solvent 2 | Chemical | Water | Water | Water | Water | Water |
| | | species | | | | | |
| | | g | 40 | 40 | 40 | 40 | 40 |
| | Solvent 1/solvent 2 | | 9/1 | 9/1 | 9/1 | 9/1 | 9/1 |
| | Stat of liquid | | Homogeneously | Homogeneously | Homogeneously | Homogeneously | Homogeneously |
| | | | dissolved | dissolved | dissolved | dissolved | dissolved |
| | Imidization rate | | 0.02 | 0.02 | 0.05 | 0.08 | 0.02 |
| | Molecular weight | Mn | 20,000 | 20,000 | 10,000 | 20,000 | 20,000 |
| | Solid content | % | 20 | 20 | 20 | 20 | 20 |
| | Viscosity | Pa · s | 150 | 150 | 90 | 150 | 150 |
| Amine | Organic amine | Chemical | MAEt | ETA | DMAEt | DMAEt | DMAEt |
| salt-making | compound | species | | | | | |
| step | | g | 35.62 | 24.4 | 35.62 | 35.62 | 106.86 |
| | | mmol | 399.5 | 399.5 | 399.5 | 399.5 | 1198.5 |
| | Added solvent | Chemical | Water | Water | Water | Water | Water |
| | | species | | | | | |
| | | g | 400 | 400 | 400 | 400 | 900 |
| | Treatment rate | Mol % | 100 | 100 | 100 | 100 | 300 |

| | State of liquid | | Homogeneously | Homogeneously | Homogeneously | Homogeneously | Homogeneously |
|---|---|---|---|---|---|---|---|
| | | | dissolved | dissolved | dissolved | dissolved | dissolved |
| Solvent | State of liquid | | Homogeneously | Homogeneously | Homogeneously | Homogeneously | Homogeneously |
| replacement | | | dissolved | dissolved | dissolved | dissolved | dissolved |
| step | Solid content | % | 18 | 18 | 15 | 18 | 9 |
| | Viscosity | Pa · s | 160 | 180 | 80 | 148 | 60 |
| | Moisture content in solvent | % | 90 | 88 | 92 | 96 | 98 |
| Film | Void mark | | A | A | A | A | A |
| formability | Surface unevenness/pattern | | A | A | A | A | A |
| Mechanical | Tensile strength | Mpa | 190 | 190 | 190 | 190 | 210 |
| properties | Tensile elongation | % | 80 | 80 | 80 | 80 | 85 |

| Example/Comparative example | | | Example 15 | Example 16 | Example 17 | Example 18 | Example 19 |
|---|---|---|---|---|---|---|---|
| Polyimide precursor composition | | | E-2 | E-3 | F-1 | F-2 | F-3 |
| Polymeriza- | Tetracarboxylic | Chemical | BPDA | BPDA | BPDA | BPDA | BPDA |
| tion step | dianhydride | species | | | | | |
| | | g | 58.77 | 58.77 | 58.77 | 58.77 | 58.77 |
| | | mmol | 199.75 | 199.75 | 199.75 | 199.75 | 199.75 |
| | Diamine | Chemical | ODA | ODA | ODA | ODA | ODA |
| | compound | species | | | | | |
| | | g | 41.23 | 41.23 | 41.23 | 41.23 | 41.23 |
| | | mmol | 205.92 | 205.92 | 205.92 | 205.92 | 205.92 |
| | Tetracarboxylic dianhydride/diamine | | 0.98 | 0.98 | 0.98 | 0.98 | 0.98 |
| | compound (molar ratio) | | | | | | |
| | Solvent 1 | Chemical | THF | THF | THF | THF | THF |
| | | species | | | | | |
| | | g | 360 | 360 | 360 | 360 | 360 |
| | Solvent 2 | Chemical | Water | Water | Water | Water | Water |
| | | species | | | | | |
| | | g | 40 | 40 | 40 | 40 | 40 |
| | Solvent 1/solvent 2 | | 9/1 | 9/1 | 9/1 | 9/1 | 9/1 |
| | Stat of liquid | | Homogeneously | Homogeneously | Homogeneously | Homogeneously | Homogeneously |
| | | | dissolved | dissolved | dissolved | dissolved | dissolved |
| | Imidization rate | | 0.02 | 0.02 | 0.08 | 0.08 | 0.06 |
| | Molecular weight | Mn | 20,000 | 20,000 | 20,000 | 20,000 | 20,000 |
| | Solid content | % | 20 | 20 | 20 | 20 | 20 |
| | Viscosity | Pa · s | 150 | 150 | 150 | 150 | 150 |
| Amine | Organic amine | Chemical | DMAEt | DMAEt | DMAEt | DMAEt | DMAEt |
| salt-making | compound | species | | | | | |
| step | | g | 89.05 | 71.24 | 106.86 | 89.05 | 71.24 |
| | | mmol | 998.75 | 799 | 1198.5 | 998.75 | 799 |
| | Added solvent | Chemical | Water | Water | Water | Water | Water |
| | | species | | | | | |
| | | g | 900 | 900 | 900 | 900 | 900 |
| | Treatment rate | Mol % | 250 | 200 | 300 | 250 | 200 |

| | State of liquid | | Homogeneously | Homogeneously | Homogeneously | Homogeneously | Homogeneously |
|---|---|---|---|---|---|---|---|
| | | | dissolved | dissolved | dissolved | dissolved | dissolved |
| Solvent | State of liquid | | Homogeneously | Homogeneously | Homogeneously | Homogeneously | Homogeneously |
| replacement | | | dissolved | dissolved | dissolved | dissolved | dissolved |
| step | Solid content | % | 9 | 9 | 12 | 9 | 9 |
| | Viscosity | Pa · s | 55 | 50 | 80 | 70 | 60 |
| | Moisture content in solvent | % | 98 | 98 | 70 | 80 | 85 |
| Film | Void mark | | A | A | A | A | A |
| formability | Surface unevenness/pattern | | A | A | A | A | A |
| Mechanical | Tensile strength | Mpa | 200 | 190 | 210 | 190 | 180 |
| properties | Tensile elongation | % | 80 | 80 | 85 | 80 | 75 |

TABLE 3

| | | | Example/Comparative example | | | | | | | |
|---|---|---|---|---|---|---|---|---|---|---|
| | | | Exam- | Exam- | Exam- | Exam- | Exam- | Exam- | Exam- | Exam- |
| | | | ple 20 | ple 21 | ple 22 | ple 23 | ple 24 | ple 25 | ple 26 | ple 27 |
| Polyimide precursor composition | | | G-1 | G-2 | H-1 | H-2 | I-1 | I-2 | J-1 | J-2 |
| Polymeriza- | Tetracarboxylic | Chemical | BPDA | BPDA | BPDA | PMDA | BPDA | BPDA | BPDA | BPDA |
| tion step | dianhydride | species | | | | | | | | |
| | | g | 58.77 | 58.77 | 72.52 | 51.38 | 58.77 | 56.94 | 58.77 | 58.77 |
| | | mmol | 199.75 | 199.75 | 246.48 | 235.56 | 199.75 | 193.53 | 199.75 | 199.75 |
| | Diamine compound | Chemical | ODA | ODA | PDA | ODA | ODA | ODA | ODA | ODA |
| | | species | | | | | | | | |
| | | g | 41.23 | 41.23 | 27.48 | 48.62 | 41.23 | 43.09 | 41.23 | 41.23 |
| | | mmol | 205.92 | 205.92 | 254.12 | 242.77 | 205.92 | 215.04 | 205.92 | 205.92 |
| | Tetracarboxylic dianhydride/diamine | | 0.98 | 0.98 | 0.98 | 0.98 | 0.98 | 0.9 | 0.98 | 0.98 |
| | compound (molar ratio) | | | | | | | | | |
| | Solvent 1 | Chemical | MEK | IPA | THF | DOX | THF | THF | THF | THF |
| | | species | | | | | | | | |
| | | g | 360 | 360 | 360 | 360 | 320 | 320 | 320 | 320 |
| | Solvent 2 | Chemical | Water | Water | Water | Water | Water | Water | Water | Water |
| | | species | | | | | | | | |
| | | g | 40 | 40 | 40 | 40 | 80 | 80 | 80 | 80 |
| | Solvent 1/solvent 2 | | 9/1 | 9/1 | 9/1 | 9/1 | 8/2 | 8/2 | 8/2 | 8/2 |
| | Stat of liquid | | Homo- | Homo- | Homo- | Homo- | Homo- | Homo- | Homo- | Homo- |
| | | | geneously | geneously | geneously | geneously | geneously | geneously | geneously | geneously |
| | | | dissolved | dissolved | dissolved | dissolved | dissolved | dissolved | dissolved | dissolved |
| | Imdization rate | | 0.08 | 0.03 | 0.08 | 0.05 | 0.03 | 0.03 | 0.18 | 0.13 |
| | Molecular weight | Mn | 20,000 | 20,000 | 20,000 | 20,000 | 15,000 | 1,200 | 12,000 | 12,000 |
| | Solid content | % | 20 | 20 | 20 | 20 | 20 | 20 | 20 | 20 |
| | Viscosity | Pa · s | 150 | 150 | 150 | 150 | 140 | 2 | 140 | 140 |
| Amine | Organic amine | Chemical | DMAEt | DMAEt | DMAEt | DMAEt | DMAEt | DMAEt | DMAEt | DMAEt |
| salt-making | compound | species | | | | | | | | |
| step | | g | 35.62 | 35.62 | 35.62 | 35.62 | 35.62 | 35.62 | 35.62 | 35.62 |
| | | mmol | 399.5 | 399.5 | 399.5 | 399.5 | 399.5 | 399.5 | 399.5 | 399.5 |
| | Added solvent | Chemical | Water | Water | Water | Water | Water | Water | Water | Water |
| | | species | | | | | | | | |
| | | g | 400 | 400 | 400 | 400 | 400 | 400 | 400 | 400 |
| | Treatment rate | Mol % | 100 | 100 | 100 | 100 | 100 | 100 | 100 | 100 |

| | State of liquid | | Homo- | Homo- | Homo- | Homo- | Homo- | Homo- | Homo- | Homo- |
|---|---|---|---|---|---|---|---|---|---|---|
| | | | geneously | geneously | geneously | geneously | geneously | geneously | geneously | geneously |
| | | | dissolved | dissolved | dissolved | dissolved | dissolved | dissolved | dissolved | dissolved |
| Solvent | State of liquid | | Homo- | Homo- | Homo- | Homo- | Homo- | Homo- | Homo- | Homo- |
| replacement | | | geneously | geneously | geneously | geneously | geneously | geneously | geneously | geneously |
| step | | | dissolved | dissolved | dissolved | dissolved | dissolved | dissolved | dissolved | dissolved |
| | Solid content | % | 18 | 18 | 18 | 18 | 18 | 18 | 18 | 18 |
| | Viscosity | Pa · s | 148 | 148 | 148 | 148 | 148 | 2 | 148 | 148 |
| | Moisture content in solvent | % | 60 | 80 | 92 | 80 | 96 | 80 | 96 | 96 |
| Film | Void mark | | A | A | A | A | A | A | B | A |
| formability | Surface unevenness/pattern | | A | A | A | A | A | A | B | A |
| Mechanical | Tensile strength | Mpa | 190 | 190 | 400 | 120 | 190 | 160 | 230 | 210 |
| properties | Tensile elongation | % | 80 | 80 | 35 | 60 | 80 | 70 | 110 | 105 |

TABLE 4

| | | | Example/Comparative example | | | | | | |
|---|---|---|---|---|---|---|---|---|---|
| | | | Comparative | Comparative | Comparative | Comparative | Comparative | Comparative | Comparative |
| | | | example 1 | example 2 | example 3 | example 4 | example 5 | example 6 | example 7 |
| Polyimide precursor composition | | | X-1 | X-2 | X-3 | X-4 | X-5 | X-6 | X-7 |
| Polymeriza- | Tetracarboxylic | Chemical | BPDA | → | BPDA | PMDA | BPDA | BPDA | BPDA |
| tion step | dianhydride | species | | | | | | | |
| | | g | 58.77 | → | 58.77 | 58.77 | 58.77 | 58.77 | 58.77 |
| | | mmol | 199.75 | → | 199.75 | 199.75 | 199.75 | 199.75 | 199.75 |
| | Diamine | Chemical | ODA | → | ODA | ODA | ODA | ODA | ODA |
| | compound | species | | | | | | | |
| | | g | 41.23 | → | 41.23 | 41.23 | 41.23 | 41.23 | 41.23 |
| | | mmol | 205.92 | → | 205.92 | 205.92 | 205.92 | 205.92 | 205.92 |
| | Tetracarboxylic dianhydride/ | | 0.98 | → | 0.98 | 0.98 | 0.98 | 0.9 | 0.98 |
| | diamine compound (molar ratio) | | | | | | | | |
| | Solvent 1 | Chemical | NMP | → | NMP | THF | THF | THF | THF |
| | | species | | | | | | | |
| | | g | 400 | → | 400 | 360 | 360 | 360 | 360 |
| | Solvent 2 | Chemical | — | → | — | Water | Water | Water | Water |
| | | species | | | | | | | |
| | | g | — | → | — | 40 | 40 | 40 | 40 |
| | Solvent 1/solvent 2 | | 10/0 | → | 10/0 | 9/1 | 9/1 | 9/1 | 9/1 |
| | Stat of liquid | | Homo- | Homo- | Homo- | Homo- | Homo- | Homo- | Homo- |
| | | | geneously | geneously | geneously | geneously | geneously | geneously | geneously |
| | | | dissolved | dissolved | dissolved | dissolved | dissolved | dissolved | dissolved |
| | Imidization rate | | 0.02 | 0.02 | 0.02 | 0.22 | 0.02 | 0.02 | 0.02 |

| | | | | | | | | | |
|---|---|---|---|---|---|---|---|---|---|
| | Molecular weight | Mn | 12,000 | → | 1,000 | — | 20,000 | 20,000 | 20,000 |
| | Solid content | % | 20 | → | 20 | — | 20 | 20 | 20 |
| | Viscosity | Pa · s | 120 | → | 5 | — | 150 | 150 | 150 |
| Amine | Organic amine | Chemical | — | → | DMAEt | — | DMAEt | DMAEt | DMAEt |
| salt-making | compound | species | | | | | | | |
| step | | | | | | | | | |
| | | g | — | → | 35.62 | — | 14.25 | 35.62 | 185.22 |
| | | mmol | — | → | 399.5 | — | 159.8 | 399.5 | 2077.4 |
| | Added solvent | Chemical | — | → | — | — | Water | THF/Water | Water |
| | | species | | | | | | | |
| | | g | — | → | — | — | 400 | 150/150 | 400 |
| | Treatment rate | Mol % | — | → | — | — | 40 | 100 | 520 |

| | State of liquid | | — | — | — | — | Pre- | Undisolved | Partially |
|---|---|---|---|---|---|---|---|---|---|
| | | | | | | | cipitated | | gelated |
| Solvent- | State of liquid | | — | Homo- | — | — | — | Undisolved | Partially |
| replacement | | | | geneously | | | | | gelated |
| | | | | dissolved | | | | | |
| step | Solid content | % | — | 18 | — | — | — | 15 | 12 |
| | Viscosity | Pa · s | — | 120 | — | — | — | — | 5 |
| | Moisture content in solvent | % | — | 0 | — | — | — | 25 | 80 |
| Film | Void mark | | A | A | B | — | — | D | D |
| formability | Surface unevenness/pattern | | A | A | B | — | — | D | D |
| Mechanical | Tensile strength | Mpa | 80 | 70 | 50 | — | — | 170 | 40 |
| properties | Tensile elongation | % | 20 | 10 | 10 | — | — | 10 | 10 |

From the above results, it is understood that the evaluation results of the film formability and mechanical properties obtained from the present examples are better than those obtained from comparative examples.

The respective abbreviations in Tables 1 to 4 are as follows. Moreover, “-” in Tables 1 to 4 indicates that the component is not added or measured, and “→” indicates that the cell includes the same data as that of the left column.

Tetracarboxylic acid: “BPDA” (3,3′,4,4′-biphenyltetracarboxylic dianhydride), “PMDA” (pyromellitic dianhydride)

Diamine compound: “ODA” (4,4′-diaminodiphenylether), “PDA” (p-phenylenediamine)

Organic amine compound: DMAEt (dimethylaminoethanol: tertiary amine: a boiling point by of 133° C. to 134° C.), γ-Pyc (γ-picoline: tertiary amine: a boiling point by of 145° C.), MAEt (N-methylethanolamine: secondary amine: a boiling point by of 156° C.), ETA (2-ethanolamine: primary amine: a boiling point by of 170° C.)

Solvent: THF (tetrahydrofuran: water-soluble ether solvent: a boiling point by of 67° C.), DOX (dioxane: water-soluble ether solvent: a boiling point by of 102° C.), ATN (acetone: water-soluble ketone solvent: boiling point by of 56° C.), MEK (methyl ethyl ketone; water-soluble ketone solvent: a boiling point by of 80° C.), IPA (isopropanol: water-soluble alcohol solvent: a boiling point by of 82° C.)

In the present exemplary embodiment, the “treatment rate” in the amine salt-making step is the amount (mol %) of an organic amine compound based on the theoretical amount of a carboxyl group contained in the polyimide precursor. The theoretical amount of a carboxyl group refers to a value obtained by doubling the molar amount of tetracarboxylic acid contained in the polyimide precursor.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A polyimide precursor composition, comprising:
an organic amine compound and a resin which contains a repeating unit represented by the following Formula (I) and has an imidization rate of 0.2 or less dissolved in a solvent containing water and one or more kinds of organic solvents selected from a water-soluble ether solvent, a water-soluble ketone solvent, and a water-soluble alcohol solvent: 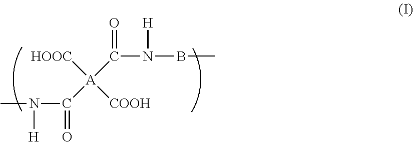
wherein A represents a tetravalent organic group, and B represents a divalent organic group.

2. The polyimide precursor composition according to claim 1,
wherein in the Formula (I), A represents a tetravalent aromatic organic group, and B represents a divalent aromatic organic group.

3. The polyimide precursor composition according to claim 1,
wherein a content of water is from 30% by weight to 99.9% by weight based on the entire solvent.

4. The polyimide precursor composition according to claim 1,
wherein a content of water is from 50% by weight to 99.9% by weight based on the entire solvent.

5. The polyimide precursor composition according to claim 1,
wherein a content of water is from 80% by weight to 99.9% by weight based on the entire solvent.

6. The polyimide precursor composition according to claim 1,
wherein the solvent contains an water-soluble ether solvent and water.

7. The polyimide precursor composition according to claim 1,
wherein the solvent contains a water-soluble ketone solvent and water.

8. The polyimide precursor composition according to claim 1,
wherein a content of the organic amine compound is from 50 mol % to 500 mol % based on a carboxyl group contained in the resin.

9. The polyimide precursor composition according to claim 1,
wherein the organic amine compound is at least one kind selected from a secondary amine compound and a tertiary amine compound.

10. The polyimide precursor composition according to claim 1,
wherein the resin includes a resin having an amino group on the terminal thereof.

11. The polyimide precursor composition according to claim 1,
wherein a number average molecular weight of the resin is from 1,000 to 100,000.

12. A method for preparing a polyimide precursor composition, comprising:
forming a resin by polymerizing a tetracarboxylic dianhydride and a diamine compound in a solvent containing water and one or more kinds of organic solvents selected from a water-soluble ether solvent, a water-soluble ketone solvent, and a water-soluble alcohol solvent; and
adding an organic amine compound to the solvent after the resin is formed.

13. The method for preparing a polyimide precursor composition according to claim 12,
wherein in the adding of an organic amine compound, after the resin is formed, water is added to the solvent so as to separate the resin from the solvent, and water and the organic amine compound are added to the rest in which a portion of the solvent obtained after the separation is removed.

14. The method for preparing a polyimide precursor composition according to claim 12,
wherein in the adding of an organic amine compound, after the resin is formed, an organic amine compound is added to the rest remaining after a portion of the solvent is distilled away or added to the rest while a portion of the solvent is being distilled away.

15. The method for preparing a polyimide precursor composition according to claim 12,
wherein a boiling point of the organic solvents is 160° C. or less.

16. The method for preparing a polyimide precursor composition according to claim 12,
wherein a boiling point of the organic amine compound is from 60° C. to 200° C.
